(19) United States
(12) Patent Application Publication
(10) Pub. No.: US 2024/0409474 A1
(43) Pub. Date: Dec. 12, 2024

(54) COMPONENT PRODUCED USING AN INFILTRATION PROCESS, DEVICE COMPRISING SAID COMPONENT, AND INFILTRATION PROCESS FOR PRODUCING A COMPONENT

(71) Applicant: Schunk Ingenieurkeramik GmbH, Willich-Münchheide (DE)

(72) Inventors: Lars SCHNETTER, Wimbach (DE); Philipp GINGTER, Mönchengladbach (DE); Clara MINAS-PAYAMYAR, Düsseldorf (DE); Dustin KERSBERG, Willich-Münchheide (DE)

(21) Appl. No.: 18/693,997

(22) PCT Filed: Sep. 29, 2021
(86) PCT No.: PCT/EP2021/076820

§ 371 Date: Mar. 21, 2024

(51) Int. Cl. C04B 41/50; C04B 38/00; C04B 41/00; C04B 41/45; C04B 41/88

(52) U.S. Cl. CPC C04B 41/5096; C04B 38/0096; C04B 41/009; C04B 41/4523; C04B 41/4558; C04B 41/88

(57) ABSTRACT

A component includes a component body in which at least one cavity is formed, wherein a wall surface of the component body, which wall surface delimits the cavity, is at least partially coated with a coating. The design of the component is based on a porous preform made in one or more parts from an inorganic matrix (M1), the preform having the cavity and a porous pre-coating made from an inorganic matrix (M2), the pre-coating coating at least part of a wall surface of the preform that delimits the cavity The porous preform and the porous pre-coating are infiltrated with an inorganic infiltrate (M3). The infiltrated preform forms the component body, and the infiltrated pre-coating forms the coating. A method for producing the component, wherein the preform and the pre-coating are infiltrated so as to produce the component body comprising the coating is also disclosed.

The invention relates to a component according to claim 1, to an apparatus comprising said component according to claim 13 and to a process for producing a component according to claim 14.

Production of various components, for example ceramic carrier elements (for example chucks) on which semiconductor wafers are held during lithographic processing thereof may employ infiltration processes where a molten mass infiltrates a preform/precursor body composed of porous material. A well-known representative of these infiltration processes is the infiltration of a precursor body composed of porous ceramic material such as silicon carbide with a silicon melt. During infiltration, the infiltrate reacts with carbon within the porous ceramic material to form secondary silicon carbide (SiC or in-situ SiC). This secondary silicon carbide grows epitaxially on the primary silicon carbide grains as described, for example, in the article by J. N. Ness, T. F. Page, Microstructural Evolution in reaction-bonded Silicon Carbide, Journal of Materials Science 21 (1986), 1377-1397.

A very wide variety of carbon-containing precursor materials may be used to introduce the carbon into the precursor body before infiltration, for example pitch, phenols, furfuryl alcohol, carbohydrates such as sugar, etc. The precursor body comprising the carbon-containing precursor material is initially heated to over 600° C. in an inert atmosphere to convert the carbon-containing precursor material into carbon prior to the infiltration. Subsequently, the precursor body is contacted with a silicon metal or a silicon alloy in an inert environment or in a vacuum atmosphere and heated to above the melting point of the infiltrating material. Through self-wetting and reaction between the carbon and the molten silicon (Si) the precursor body is completely infiltrated. The carbon in the precursor body reacts with the Si, thus forming in situ SiC. The in situ SiC forms a scaffold within the porous preform. What is typically desired is a dense component body where all pores are filled including those in which no in situ SiC is formed. Excess silicon is then present here. The resulting composite body thus comprises silicon carbide and unreacted silicon and may be referred to as Si/SiC for short.

U.S. Pat. No. 5,509,555 A describes the production of silicon carbide composite materials by the infiltration of a porous precursor body containing carbon and/or silicon carbide using a silicon alloy which, in addition to silicon, may contain further metals, for example aluminum, copper, zinc, nickel or combinations of these. Silicon has a melting anomaly and expands upon cooling. A portion of the silicon remains on the surface of the porous precursor body, adheres tightly thereto and must therefore be removed by subsequent steps. To this end U.S. Pat. No. 5,509,555 A proposes for example powder or an etching bath with which adhering infiltrate is said to react in order thus to remove the infiltrate from the surface. This is costly and inconvenient and produces hazardous waste.

U.S. Pat. No. 5,205,970 A describes the production of reaction-bonded silicon carbide composite materials by a melt infiltration process in which a porous precursor body is infiltrated with an infiltrate. After termination of the production process excess silicon is present on the surface of the precursor body in the form of surface melt exudations, especially in the form of droplets. This is because, especially due to the melting anomaly of the silicon, a portion thereof escapes from the porous precursor body again upon cooling.

At the surface of the porous precursor body the silicon solidifies and adheres tightly, therefore requiring removal by subsequent steps to achieve a dimensionally accurate component. To this end according to U.S. Pat. No. 5,205,970 A the excess silicon is removed through contacting of the component surfaces with a carbon-based wicking material. This process requires a second high temperature cycle in which the liquidus temperature of the infiltrant is exceeded at least in the region of the surface melt exudations. Wicking materials include for example carbon-based felt, wherein the capillaries of this felt shall be at least equal in size to the capillaries of the silicon carbide composite body after termination of the reaction binding process. The capillary action of the silicon carbide composite body is then stronger than that of the wicking material. This is said to ensure that only excess silicon which has escaped at the component surface is absorbed by the felt and no silicon is withdrawn from the volume of the component.

U.S. Pat. No. 3,857,744 discloses applying boron nitride powder onto the porous precursor body prior to the infiltration. This boron nitride powder is said to reduce deposition and adhesion of silicon to the powder-covered component. A disadvantage is the need to remove the boron nitride powder again since it would otherwise end up in the environment during the later utilization of the component. This results in hazardous waste comprising boron nitride and the detached infiltrate. In addition, removal is only possible at accessible surfaces while often impossible in cavities. Since the boron nitride powder is clearly not always sufficient, the boron nitride and still-adherent silicon is removed from the component by a sandblasting operation. This is costly and inconvenient and requires an additional operating step. This is also performable only to a limited extent, if at all, at sites which are difficult to access.

WO 2005/037726 A2 describes a process for producing components of a metal-ceramic composite material comprising cavities and produced by a melt infiltration. Closure of the cavities by melt exudation of the infiltrant into the cavities is prevented by filling the cavities with a temporary filler which cannot be infiltrated by the infiltrant.

According to WO 2005/037726 A2 a non-infiltrable material is brought into contact with all walls of the cavity, so that infiltration into this material, and thus into the cavity, is prevented. The contacting is effected either by lining the cavity or by filling the entire cavity. This ensures that the non-infiltrable material is easy to remove after infiltration of the porous precursor body, which is why the non-infiltrable material is loosely bound or is in the form of a free-flowing particle mass both before and after the infiltration process. According to WO 2005/037726 A2 removal of the loosely bound or free-flowing particle mass is carried out conveniently after the infiltration process using compressed air, water, shaking or suction. However, to this end it is in some cases necessary to introduce additional bores into the cavities to make the filling material accessible for removal. These bores must then be closed again. Cost and complexity is correspondingly high and there is a risk that residues of the non-infiltrable material will cause problems and damage in later applications of the component.

It is accordingly an object of the invention to provide a less costly and complex solution for providing a component comprising a cavity free from infiltration material, especially also in the case of surface melt exudations, wherein the risk of residual impurities in the cavity is also to be reduced.

The main features of the invention are specified in claim 1 and claim 14. Embodiments are provided in claims 2 to 13 and 15.

The invention relates to a component having a component body comprising at least one cavity, wherein a wall surface of the component body delimiting the cavity is at least partially or completely coated with a coating, wherein the component is formed on the basis of
a one-piece or multi-piece porous precursor body composed of an inorganic matrix, wherein the precursor body comprises/includes the cavity,
a porous precursor coating composed of an inorganic matrix, with which a wall surface of the precursor body delimiting the cavity is at least partially coated,
and infiltration of the porous precursor body and the porous precursor coating with an inorganic infiltrate,
wherein the infiltrated precursor body forms the component body and the infiltrated precursor coating forms the coating.

The infiltration of the precursor coating and the precursor body forms a material compound between the precursor body and the precursor coating, i.e. between the component body and the coating. This results in a firmly adherent and durable coating. This need not be removed. It is especially possible to form a material bond between the coating and the component body, wherein the material bond between the coating and the component body is preferably at least partially formed by ionic bonding. In addition the solidified infiltrate can extend from the component body into the coating, thus especially forming a continuous scaffold between the precursor body and the precursor coating. This also brings about a stable bond. In terms of process engineering the interaction of the precursor coating with the infiltrate makes it possible to employ a permanent coating especially as a substitute for temporary auxiliary substances which are used in the prior art to prevent surface melt exudations. The precursor coating thus especially makes it possible to provide in the region of the cavity characteristics that deviate from the infiltration characteristics of the precursor body. While it is important in the region of the component body that the infiltrate is well distributed therein it is sufficient in the region of the precursor coating to achieve permanent bonding of said precursor coating to the component body.

The infiltrate preferably forms a (fluid-)impermeable coating in the porous precursor coating. This prevents any impurities from subsequently settling in, or even microorganisms colonizing, the coating.

The material properties of the coating and of the remaining component may be defined distinctly from one another since different inorganic matrices are selected for the precursor body and the precursor coating. In particular the matrix of the precursor coating may differ from the matrix of the precursor body, for example in terms of its micrograin size, microstructure density and/or material/material alloy.

The microstructure of the porous precursor body and the porous precursor coating is not altered by the infiltration, nor by temperature cycles that are completed during the infiltration. Through the taking of polished sections and microscopy, in particular optical microscopy or scanning electron microscopy, the microstructures are also discernible after infiltration. The infiltrate is here identifiable separately in the formerly free pores. Energy-dispersive X-ray spectroscopy (EDX) also makes it possible to identify different materials in the microstructure, i.e. in particular the materials of the precursor body, of the precursor coating and of the infiltrate and materials formed by reaction.

The precursor body should have at least one free surface having no such (especially functionally equivalent during infiltration) precursor coating. The component should accordingly have at least one free surface which does not comprise such a coating (especially formed by infiltration of a porous precursor coating). An optimization in terms of the infiltration into the precursor body may thus be carried out in the region of the free surfaces. It is preferable when at most 30% of the entire surface of the precursor body is coated with the precursor coating. It is likewise preferable when at least 70% of the entire surface of the precursor body is free surface without such a precursor coating where surface melt exudations of the infiltrate are especially possible.

In a more particular embodiment it is provided that the precursor coating has a poorer wettability with respect to the infiltrate than the precursor body and/or the matrix of the precursor coating and the matrix of the precursor body are each formed from a microstructure, wherein the microstructure of the matrix of the precursor coating is finer than the microstructure of the matrix of the precursor body. At low wettability infiltrate is less strongly induced to infiltrate the material of the precursor coating. The infiltration thus occurs primarily in the precursor body. By contrast, infiltration into the precursor coating tends to be slow both from the free outer surface and from the side facing the precursor body.

At the same time infiltrate which unintentionally ends up on the free surface of the precursor coating adheres less strongly than in the region of the precursor body, that is to say it is less strongly absorbed into the pores of the coating. This ensures that the coating remains free of strong adhesions after solidification of the infiltrate. A finer microstructure forms a mechanical obstacle to the infiltrate whose viscosity is typically matched to the porosity of the precursor body to be infiltrated. In addition, finer capillaries hold infiltrate that has already penetrated more firmly in the pores of the precursor coating than in the pores of the precursor body. During melting infiltrate thus seeks a path to the outside past the precursor coating. Surface melt exudations into the cavity can be reduced or even prevented by the precursor coating.

In a special variant the microstructure of the matrix of the precursor coating has a primary grain size of 0.1 μm to 100 μm, preferably of 0.2 μm to 60 μm, more preferably of 0.5 μm to 30 μm, yet more preferably of 0.8 μm to 8 μm and particularly preferably of 1 μm to 6 μm. Due to the small grain size of the microstructure (also known as fine-crystalline) and the resulting small particle interspaces the infiltrate has a lower infiltration tendency into the precursor coating, than into the precursor body.

There is further the option that the microstructure of the matrix of the precursor body has a primary grain size of 0.1 μm to 500 μm, preferably of 0.2 μm to 400 μm, more preferably of 0.5 μm to 300 μm, yet more preferably of 1 μm to 250 μm and particularly preferably of 2 μm to 200 μm. This grain size still ensures a sufficient capillary action which promotes infiltration. The optional use of additional carbon in fine-particulate form in the precursor body in conjunction with this primary grain size also achieves an elevated wettability on and in the precursor body.

The primary grain sizes should be combined in terms of their value ranges in such a way that the microstructure of the matrix of the precursor coating is finer than the microstructure of the matrix of the porous precursor body, in particular also when overlapping value ranges coincide.

The determination of the primary grain size may be carried out in the preliminary stage by laser diffraction particle size analysis/laser granulometic measurement of the raw material. The primary grain size may be determined by the taking of polished sections and optical microscopy or electron microscopy after production of the precursor body and the precursor coating or on the later component.

In particular the precursor coating has a lower infiltration tendency with respect to the infiltrate than the precursor body, in particular due to the poorer wettability and/or the finer microstructure. Any adhesions of infiltrate on the coating are therefore easy to remove. In addition the infiltrate is more freely distributed in the precursor body and thus primarily seeks paths through the precursor body, i.e. past the precursor coating, in the case of thermal volume changes of the infiltrate during infiltration and cooling.

Surface melt exudation of the infiltrate and deposits of the infiltrate after termination of the infiltration are thus reduced primarily to free surfaces of the component that have not been correspondingly precoated. For one thing, the low infiltration tendency of the precursor coating for example partially blocks surface exudations on their path from the inside to the outside. Should infiltrate arrive from outside onto the wall surfaces provided with precursor coating it will in any case form low bonding forces with the coating on account of the low infiltration tendency so that cooled infiltrate can be removed by methods with moderate material removing power, such as for instance shaking, vibrating or introducing compressed air or water.

The entire wall surface defining the cavity is optionally coated with the precursor coating.

The precursor body, infiltrate and precursor coating are distinguishable in the component through the taking of polished sections and microscopy, for example optical microscopy or electron microscopy.

It is preferable when the component is composed of a metal-ceramic composite material produced by melt infiltration and optionally reaction bonding plus the coating. The metal-ceramic composite material may be silicon-infiltrated reaction-bonded silicon carbide (SiC) (also known as SiSiC or RBSiC). The process chain for producing SiC typically involves the following steps: Initially a suitable shaping process (pressing, (pressure) slip casting, film casting, injection molding, extrusion, stamping, 3D printing) is used to produce the porous precursor body, typically consisting substantially of silicon carbide, carbon and/or further organic auxiliary substances. In a subsequent high temperature treatment under a vacuum and/or protective gas atmosphere this precursor body is infiltrated with molten silicon or an alloy therewith. The infiltrating silicon reacts with the carbon by dissolution and re-precipitation to form so-called secondary silicon carbide which grows epitaxially on the primary silicon carbide grains. This is described for example in the article by J. N. Ness, T. F. Page, Microstructural Evolution in reaction-bonded silicon carbide, Journal of Materials Science 21 (1986), 1377-1397, to which reference is hereby made. The porosity of the precursor body remaining after completion of the reaction is filled by unreacted free silicon, wherein an excess of silicon is used to secure complete pore filling. However, this silicon excess has an adverse effect in that during cooling, on falling below the liquidus temperature, surface melt exudations of the silicon are formed, silicon exhibiting a volume expansion of about 10% upon solidification. These silicon melt exudations are formed on the surface of the component in a very largely uncontrolled manner and aggregate in geometrically susceptible volumes (for example depressions, internal cavities and the like). Subsequent removal of the silicon melt exudations via sandblasting processes for example is possible only in appropriately accessible regions. The precursor coating according to the invention ensures that the silicon melt exudations are formed predominantly on the surfaces of the component body that comprise no such precursor coating. The melt exudations can thus be concentrated on non-critical areas.

The coating is particularly preferred in embodiments where the infiltrate exhibits a melting anomaly such that it expands upon solidification. Any surface melt exudations are concentrated on the free surface here. The infiltrate especially cannot penetrate the precursor coating or at least cannot penetrate the precursor coating without strong counterpressure from inside and consequently cannot solidify and form a strong bond with the coating in the cavity. A free cavity is thus achieved without much cost and complexity.

In a more particular embodiment it is provided that the precursor body comprises a higher proportion of a reaction partner (for example carbon) for the infiltrate than the precursor coating and in particular in the resulting component the proportion of infiltrate that has reacted with the reaction partner to free infiltrate is greater within the matrix in the precursor body than within the matrix of the precursor coating. Reaction partners such as for example carbon can in particular increase the wettability of the precursor body and vice versa a lack of such reaction partners in the precursor coating can keep the wettability low there.

In a more particular embodiment of the component it is provided that the cavity forms a channel or a channel structure. This makes the component suitable for example as a heatsink. The coating especially makes it possible to produce heatsinks having small channel diameters and complex geometries without any danger of blockages due to surface melt exudations. The channel may thus be a cooling channel, in particular for conducting a cooling medium. The channel may alternatively be an evacuation channel, in particular for fixing workpieces such as for instance silicon wafers.

It is preferable when the inorganic matrix of the precursor body is at least substantially or completely formed from the material group of silicon carbide, boron carbide, diamond or combinations of these materials. These are especially suitable for forming an infiltrable precursor body.

In one embodiment the inorganic matrix of the precursor body is at least substantially or completely formed from the material group of silicon carbide, boron carbide, diamond, molybdenum disilicide, silicon nitride, titanium carbide, zirconium carbide, aluminum nitride, tungsten carbide or combinations of these materials. Impurities that are unavoidable as a consequence of production are also comprehended and are also included under this feature. This also applies to all further material definitions in this document.

For example, the infiltrate may be silicon or an alloy of silicon especially with aluminum and/or boron and/or copper. Impurities that are unavoidable as a consequence of production are also comprehended and are included under this feature. This infiltrate allows particularly good infiltration of the porous precursor body, in particular also including a reaction with optional carbon in the inorganic matrix to afford secondary silicon carbide.

The silicon alloy may also comprise one or more metals for example. The metal(s) may especially be selected from the group of metals aluminum, copper, titanium, nickel, magnesium, zinc, cobalt, chromium, silver, gold or any alloy of these metals. Such a silicon alloy has a melting anomaly that is lower compared to pure silicon, i.e. the volume expansion during solidification can be reduced. Component stresses and surface exudations are therefore low.

The infiltrate is particularly preferably an alloy comprising silicon and at least one of the materials aluminum and/or boron.

Particular preference is given to an embodiment in which the inorganic matrix of the precursor body is based on a first silicon carbide, the precursor coating on a second silicon carbide and the infiltrate on silicon. It is also possible for the precursor body to contain carbon as a reaction partner for the infiltration of silicon to afford secondary silicon carbide.

The inorganic matrix of the precursor body may also be formed for example from one or more of the primary substances silicon carbide, boron carbide and/or carbon or from a combination thereof and one or more metals. Here too, the metal may especially be selected from the group of metals silicon, aluminum, copper, titanium, nickel, magnesium, zinc, cobalt, chromium, silver, gold or any alloy of these metals. The metal may in particular reduce the melting anomaly.

In a preferred embodiment a material bond is formed between the coating and the component body, wherein the material bond between the coating and the component body is preferably formed to an extent of at least 30%, and more preferably predominantly, by an ionic bond. This results in a strong and durable coating which is not or need not be removed during or after production. To this end the proportion of ionic bonds should predominate relative to the proportion of covalent bonds. The ionic bond (also known as a heteropolar bond or electrovalent bond) is a chemical bond based on the electrostatic attraction of positively and negatively charged ions.

One particular feature may be that the precursor coating is formed by a cast composed of a slip that is formed on the wall surface delimiting the cavity. Such a grown cast forms an initially fine-pored surface having a relatively homogeneous layer thickness, and does so especially with low technical complexity. In slip casting a cast is especially to be understood as meaning that a solidified deposit of the slip has been achieved.

Cast formation is based on the porosity and the resulting capillary forces of the precursor body. These capillary forces remove the dispersant (preferably water) from the slip and accumulation of solids particles from the slip occurs at the wall surface (“cast formation”).

The precursor coating may alternatively be deposited on the wall surface delimiting the cavity by a gas phase process. This also allows homogeneous application. A drying of the precursor body as may be necessary from a process engineering point of view when using a slip/slip casting process is not necessary here. The gas phase process may be performed for example by a CVD (chemical vapor deposition) process or a PVD (physical vapor deposition) process. These processes make it possible to achieve thin coatings of uniform thickness.

Specifically the precursor coating may be formed from or consist of a coating material which at least substantially corresponds to the material of the precursor body. The material is thus type-specific and corresponds to the matrix material of the precursor body. It therefore need not be removed from the wall surface after the infiltration. In both production and application the coating at least partially has the same material properties as the matrix of the precursor body. Thermal expansion stresses between the coating and the precursor body are also low and the coating remains intact.

In an advantageous embodiment it is provided that the coating comprises a lower proportion or no proportion of carbon before infiltration so that in particular after infiltration of the precursor body with the infiltrate there is proportionately less reaction material that has reacted with the infiltrate to afford carbides in the coating than in the precursor body.

It may further be provided that the precursor coating has a thickness of 0.01 mm to 1.0 mm, preferably 0.02 mm to 0.5 mm and particularly preferably of 0.05 mm to 0.2 mm. These coating thicknesses fulfill their purpose as a barrier to the infiltrate but it is nevertheless possible to provide very small cavities which may also be arranged very close to one another. The lower the layer thickness, the closer to one another the cavities in the precursor body may be arranged before application of the precursor coating.

The cavity preferably has a diameter of 2 mm to 25 mm. These are therefore cavities that cannot easily be post-processed from the inside since neither a hand, a person nor larger tools can fit inside. Such small diameters are at the same time particularly susceptible to closure by surface melt exudations.

One possible embodiment may consist in the component being configured as a wafer chuck. Wafers are slices of low thickness which function as blanks and from which electronic components such as integrated circuits (“chips”) are produced in multistage processes. The wafer chuck holds the wafer by means of a vacuum and/or electrostatic attraction during processing.

The invention further relates to an apparatus comprising a component as described hereinabove and hereinbelow and comprising a fluid conveying apparatus which is connected to the cavity of the component via a fluid conduit. This allows the cavity to be used for cooling or for suction-gripping a workpiece. In this assembly the component can demonstrate its advantages with the small, unblocked and cheaply producible cavities, for example in the form of a carrier/holder having cooling channels or evacuation channels.

In a more particular embodiment of the apparatus, said apparatus comprises a processing device and the component forms a workpiece holder for holding a workpiece in the processing device. The cavity, which may be configured as a channel for example, allows the workpiece to be mounted for example precisely without thermal deformation by conducting a coolant in or through the cavity. However, the cavity may optionally also open into the workpiece receiving surface of the workpiece holder, thus allowing fixing of the workpiece through evacuation of the cavity with the fluid conveying apparatus.

The invention finally also relates to a process for producing a component having a component body comprising at least one cavity comprising the steps of:
a) providing a single-piece or multi-piece porous precursor body composed of an inorganic matrix comprising a cavity;
b) forming a porous precursor coating composed of an inorganic matrix on a wall surface of the precursor body delimiting the cavity;
c) infiltrating the porous precursor body and the porous precursor coating with an inorganic infiltrate at a temperature above the liquidus temperature of the infiltrate;
d) cooling the infiltrated precursor body and the infiltrated precursor coating below the solidus temperature of the infiltrate, wherein a coating is formed from the precursor coating and the infiltrate and a component body is formed from the precursor body and the infiltrate, wherein a material compound is especially formed between the coating and the component body.

The advantage of the present invention is that the coating is securely bonded to the component body and need not be removed. While the matrix of the precursor body is optimizable in terms of the infiltration via the infiltrate, the matrix of the precursor coating can be optimized for prevention of surface melt exudations. This makes it possible to avoid blockages of the cavity and to avoid the cost and complexity of freeing the cavity from surface melt exudations and/or auxiliary substances for avoidance thereof.

In the formation of the porous precursor coating the inorganic matrix may optionally contain temporary organic constituents, for example plasticizers, binders etc. These may serve the better application of the porous precursor coating. Such organic constituents are typically burnt off during infiltration.

In a more particular process configuration it is provided that
the precursor coating has a poorer wettability with respect to the infiltrate than the porous precursor body and/or
the matrix of the precursor coating and the matrix of the precursor body are each formed from a microstructure, wherein the microstructure of the matrix of the precursor coating is finer than the microstructure of the matrix of the porous precursor body.

The infiltrate exhibits a melting anomaly such that it expands upon solidification, wherein during cooling surface melt exudations are formed at least substantially exclusively on free surfaces not covered by the precursor coating.

In the absence of surface melt exudations in the region of the coating (partial) closure of the cavity does not occur here. Instead the surface melt exudations are directed into the uncoated free surfaces where they tend to be less problematic or may at least be easily removed.

All of the features described having regard to the component may also form part of the subject matter of the process either individually or in combination as far as is necessary or sensible. The advantages thus correspond to the advantages described having regard to the apparatus features. In particular, optional developments of the process may comprise the following features for example, individually or in combination:
the low infiltration tendency of the precursor coating for example partially blocks surface exudations on their path from inside to outside;
should infiltrate get from outside onto the wall surface provided with precursor coating it may optionally be removed by shaking, vibrating or introducing compressed air or water into the cavity;
the precursor body may be composed of two or more individual parts;
the optional individual parts of the precursor body may each adjoin the cavity, in particular form wall sections of the cavity;
the precursor coating should already have been applied before infiltration of the precursor body;
the infiltration may be continued until the infiltrate projects from inside up to the precursor coating and preferably infiltrates the precursor coating from inside;
the component may be silicon-infiltrated reaction-bonded silicon carbide (SiC) (also known as SiSiC or RBSiC);
the precursor body may comprise a higher proportion of a reaction partner (for example carbon) for the infiltrate than the precursor coating;
the reaction partner may be present in an arrangement such that it has been distributed in the precursor body/incorporated therein before application of the precursor coating;
initially a suitable shaping process (pressing, (pressure) slip casting, film casting, injection molding, extrusion, stamping, 3D printing) may be used to produce the porous precursor body, for example consisting substantially of silicon carbide, carbon and/or further organic auxiliary substances;
the precursor body and the precursor coating may be infiltrated with molten silicon in a subsequent high-temperature treatment under vacuum and/or a protective gas atmosphere;
the infiltrating silicon can react with the carbon by dissolution and re-precipitation to form so-called secondary silicon carbide which grows epitaxially on primary silicon carbide grains;
the porosity of the precursor body remaining after completion of the reaction may be filled by unreacted free silicon, wherein an excess of silicon may be used to secure complete pore filling;
the formation of surface melt exudations may result due to the silicon which exhibits a volume expansion of about 10% upon solidification;
the precursor coating may be formed with a poorer wettability with respect to the infiltrate than the precursor body;
the coating of the precursor body may be formed from a finer microstructure than the porous precursor body;
the viscosity of the infiltrate may be adapted to the porosity of the precursor body to be infiltrated or vice versa the porosity may be adapted to the viscosity of the infiltrate, in particular to achieve optimal infiltration by capillary action;
the microstructure of the precursor coating may have a primary grain size of 0.1 μm to 100 μm, preferably of 0.2 μm to 60 μm, more preferably of 0.5 μm to 30 μm, yet more preferably of 0.8 μm to 8 μm and particularly preferably of 1 μm to 6 μm;
the microstructure of the precursor body may have a primary grain size of 0.1 μm to 500 μm, preferably of 0.2 μm to 400 μm, more preferably of 0.5 μm to 300 μm, yet more preferably of 1 μm to 250 μm and particularly preferably of 2 μm to 200 μm;
the precursor coating may have a lower infiltration tendency with respect to the infiltrate than the porous precursor body, in particular due to a poorer wettability and/or a finer microstructure;
the cavity may be formed in the form of a channel or a channel structure;
the inorganic matrix of the precursor body may be at least substantially or completely formed from the material group of silicon carbide, boron carbide, diamond, molybdenum disilicide, silicon nitride, titanium carbide, zirconium carbide, aluminum nitride, tungsten carbide or combinations of these materials;
the infiltration may be carried out by contacting the precursor body with the infiltrate, wherein the precursor body, the precursor coating and the infiltrate complete a common temperature cycle;
the infiltrate may be silicon or an alloy thereof;
the silicon alloy may comprise one or more metals for example;
the metal(s) may especially be selected from the group of metals aluminum, copper, titanium, nickel, magnesium, zinc, cobalt, chromium, silver, gold or any alloy of these metals;
the inorganic matrix of the precursor body may be based on a first silicon carbide, the precursor coating on a second silicon carbide and the infiltrate on silicon;
carbon may be introduced into the precursor body as a reaction partner for the infiltration of silicon to afford secondary silicon carbide; preferably before the application of the precursor coating;
the inorganic matrix may be formed from one or more of the primary substances silicon carbide, boron carbide and/or carbon or from a combination thereof and one or more metals. The metal may especially be selected from the group of metals aluminum, copper, titanium, nickel, magnesium, zinc, cobalt, chromium, silver, gold or any alloy of these metals;
a material bond may be formed between the coating and the precursor body, wherein the material bond between the coating and the infiltrated precursor body is preferably formed to an extent of at least 30%, and more preferably predominantly, by an ionic bond.
the coating may be formed as a solid and durable coating which is not removed during or after production;
the precursor coating may be formed in a slip casting process (the porous precursor body here replaces the plaster often used in slip casting processes and no demolding is carried out);
the precursor coating may be formed by a cast composed of a slip that is formed on the wall surface delimiting the cavity;
the precursor coating may be deposited onto the wall surface by a gas phase process;
the gas phase process may be performed for example by a CVD (chemical vapor deposition) process or a PVD (physical vapor deposition) process;
the precursor body may be dried after application of the precursor coating;
the precursor coating may be formed from or consist of a coating material which at least substantially corresponds to the material of the precursor body;
the precursor coating may be formed with a lower proportion or no proportion of carbon before infiltration;
the introduction of carbon into the precursor body may be carried out before application of the precursor coating;
the precursor coating may be effected with a thickness of 0.01 mm to 1.0 mm, preferably 0.02 mm to 0.5 mm and particularly preferably of 0.05 mm to 0.2 mm;
the cavity may be formed with a diameter of 2 mm to 25 mm.

Further features, details and advantages of the invention are apparent from the wording of the claims and from the following description of exemplary embodiments on the basis of the drawings. In the figures:

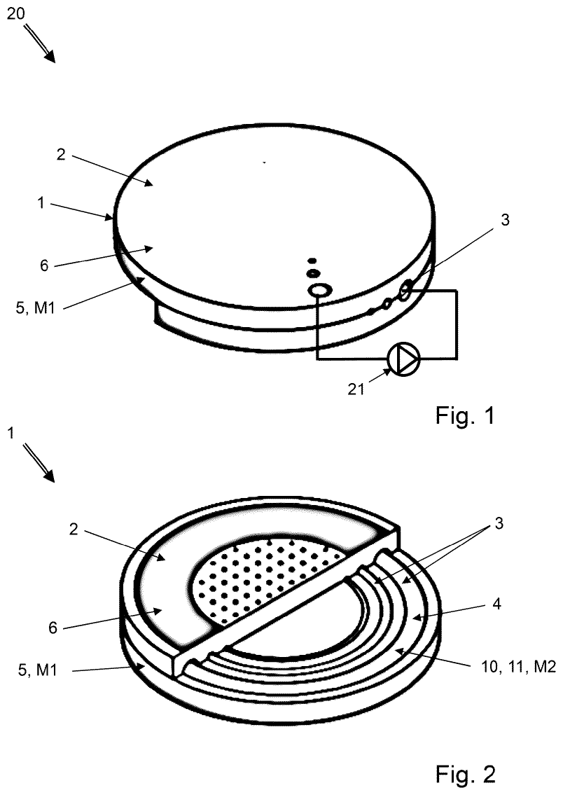

FIG. 1 shows a perspective view from obliquely above of an apparatus comprising a component and a schematic diagram of a fluid conveying apparatus;

FIG. 2 shows a perspective view from obliquely below of the component according to FIG. 1 including a partial section;

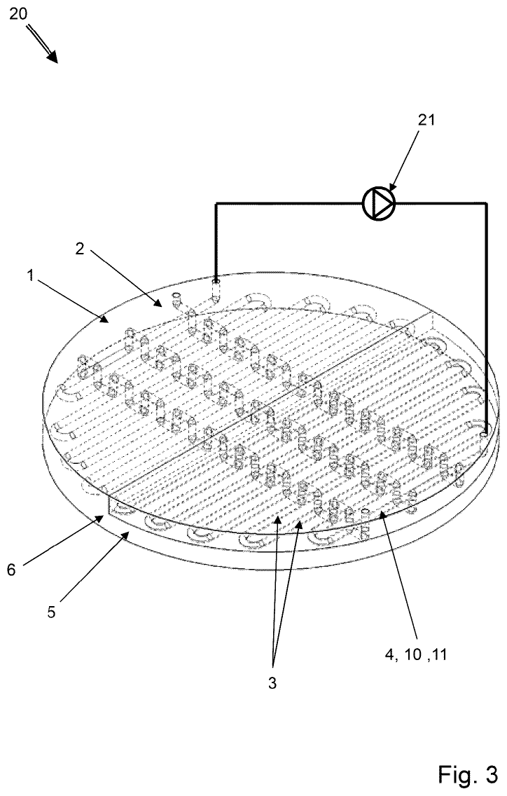

FIG. 3 shows a perspective view from obliquely above of an apparatus comprising a component and a schematic diagram of a fluid conveying apparatus, wherein the component is shown as partially transparent;

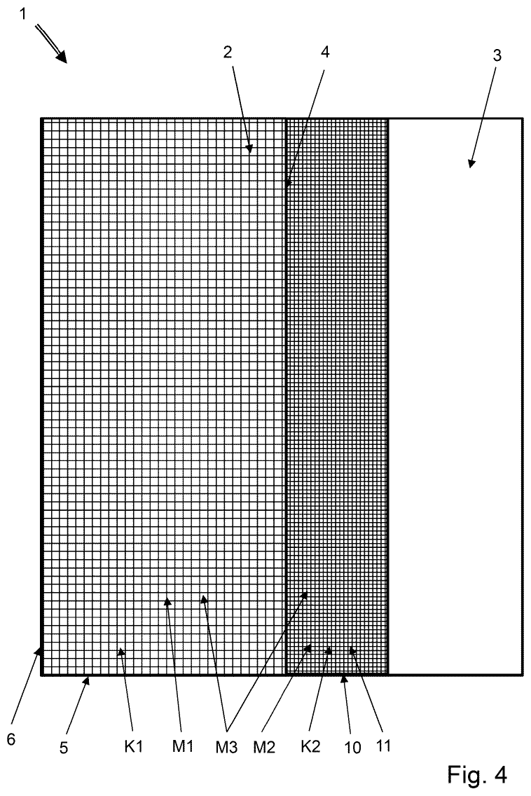

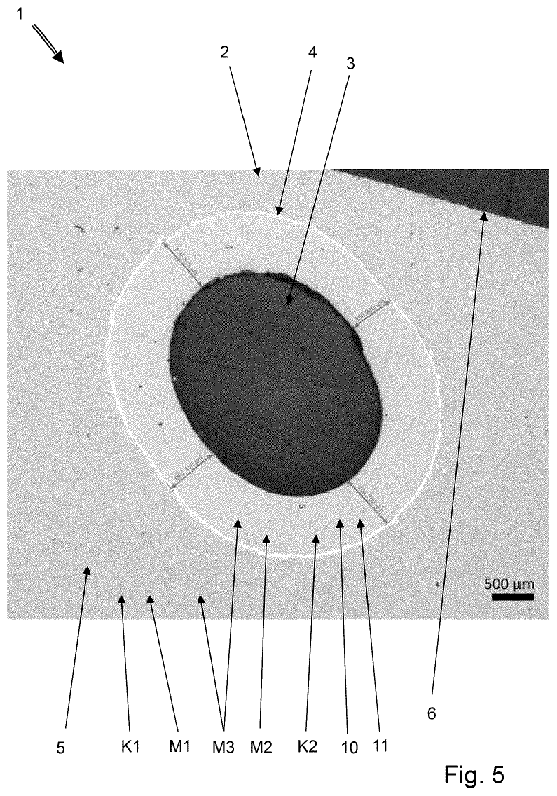

FIG. 4 shows a schematic detail section through a component;

FIG. 5 shows a polished section micrograph from an optical microscope showing a cavity in a component in cross section;

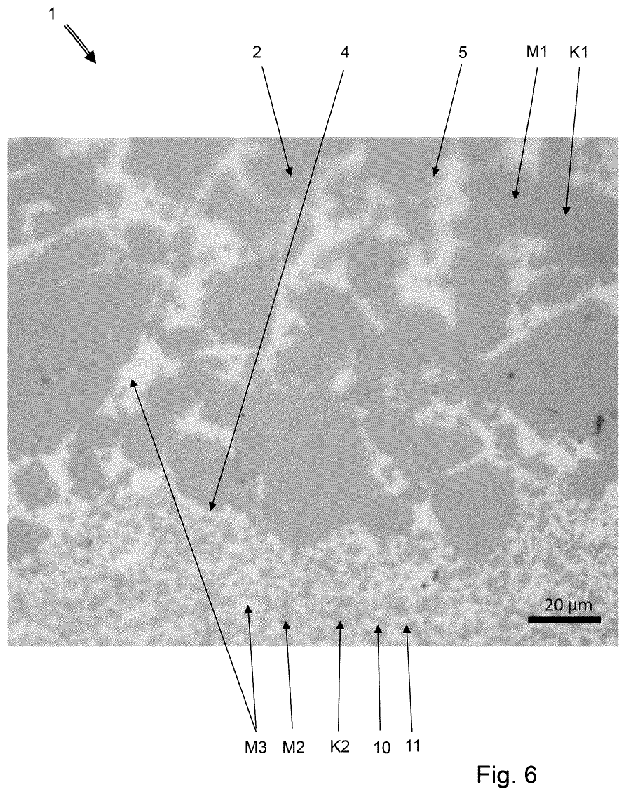

FIG. 6 shows a detail image from an optical microscope of FIG. 5 from which the microstructure of the precursor body and the precursor coating is apparent;

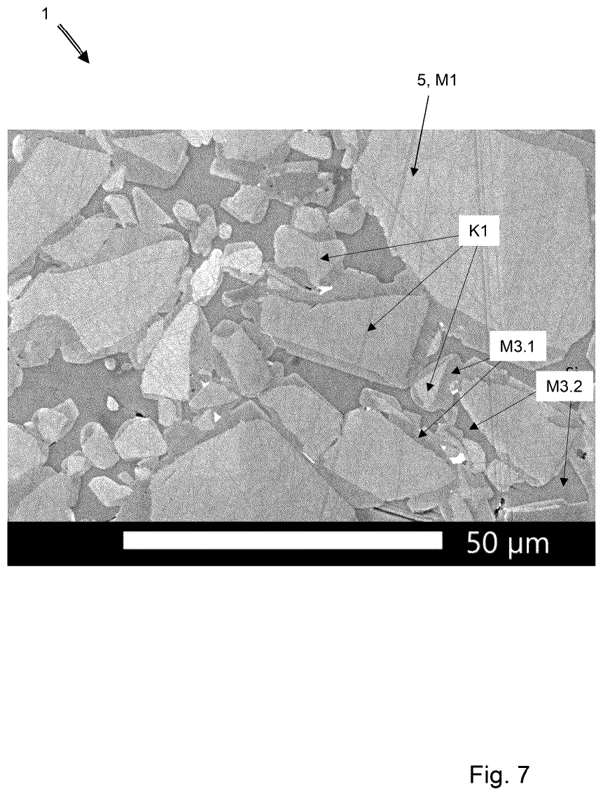

FIG. 7 shows a detail image from an electron microscope of FIG. 6 from which the differentiation between primary silicon carbide, secondary silicon carbide and free silicon is apparent; and

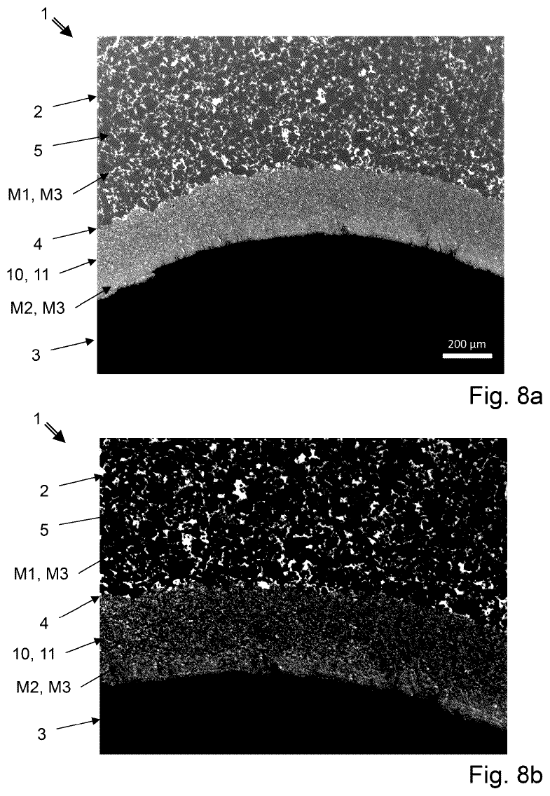

FIGS. 8a and 8b show a black-and-white detail image from an optical microscope from which the microstructure of the precursor body and the precursor coating is apparent.

FIG. 1 shows in a perspective view, from obliquely above, an apparatus 20 comprising a component 1 and a fluid conveying apparatus 21 included in schematic form. FIG. 2 again shows component 1 in a perspective view, now from obliquely below, including a partial section (this partial section is also included in FIG. 1 but hardly discernible). FIGS. 1 and 2 show a component body 2 comprising three part-annular cavities 3 which each form a channel between two openings. The openings are located on the circumference of the component body 2 and on the top surface of the component body 2.

The component body 2 is produced on the basis of a porous precursor body 5 composed of an inorganic matrix M1 composed of two joined semifinished products of SiC-carbon material (having an average particle size of 20 μm and a carbon content of 10%). The cavities 3/channels of the precursor body 5 run along the joining surface of the semifinished products and are produced by incorporating the channel bottom and/or top into the respective semifinished product. The semifinished products may be produced by subtractive manufacturing for example, by pressing or milling of sheets. The semifinished products are joined in a quasi monolithic manner with material of the same kind using state-of-the-art finishing methods. The resulting precursor body 5 thus has a plurality of channels (cavities 3) having diameters of 2 to 5 mm.

A porous precursor coating 11 of the wall surfaces 4 of the cavities 3 is applied in the form of a further inorganic matrix M2 through the two openings of the channels (cavities 3). The surfaces visible on the outside do not receive such a porous precursor coating and form free surfaces 6. The precursor coating 11 of the wall surfaces 4 is especially produced via a slip casting process. A SiC slip (especially water-based) having a primary grain size of about 5 μm and a solids content of 50% by weight is used as the coating slip. The slip is filled into the channels (cavities 3) via the openings and, after a defined time which allows for sufficient cast formation, is discharged therefrom. Due to the inherent porosity of the precursor body 5 a cast of 0.05 mm to 1 mm is thus formed at the wall surface 4 and functions as precursor coating 11. The precursor body 5 comprising the coated channels (cavities 3) is then dried at room temperature to remove the residual moisture from the intermediate product.

The precursor body 5 is then brought into contact with silicon and heated in a vacuum oven until the silicon liquefies and infiltrates the porous precursor body 5 and the porous precursor coating 11. The result of this is also apparent from the schematic detail section of FIG. 4.

The infiltration of the precursor coating 11 results in a permanent coating 10 which is firmly bonded to the component body 2 resulting from the precursor body 5 and the infiltrate M3 (see FIG. 4). This especially results in a material compound.

After complete infiltration of the precursor body 5 with silicon the component 1 is cooled and surface melt exudations are formed in the region of the free surfaces 6 due to a melting anomaly of the silicon. In the present case the surface melt exudations are removable by sandblasting. Due to the coating 10 of the wall surfaces 4 of the cavities 3 there are usually just a few, if any, small silicon beads in the cavities 3 which are removable for example by introduction of air or water. In addition the matrices M1 and M2 of the precursor body 5 and the precursor coating 11 differ. The precursor coating 11 especially has a poorer wettability with respect to the infiltrate M3 (see FIG. 4) than the precursor body 5. In addition the matrix M2 of the precursor coating 11 and the matrix M1 of the precursor body 5 are each formed from a microstructure, wherein the microstructure of the matrix M2 of the precursor coating 11 is finer than the microstructure of the matrix M1 of the precursor body 5.

The microstructure of the matrix M2 of the precursor coating 11 may have for example a primary grain size of 0.1 μm to 100 μm, preferably of 0.2 μm to 60 μm, more preferably of 0.5 μm to 30 μm, yet more preferably of 0.8 μm to 8 μm and particularly preferably of 1 μm to 6 μm. The microstructure of the matrix M1 of the precursor body 5 is coarser than that of the precursor coating 11 and has a primary grain size of 0.1 μm to 500 μm, preferably of 0.2 μm to 400 μm, more preferably of 0.5 μm to 300 μm, yet more preferably of 1 μm to 250 μm and particularly preferably of 2 μm to 200 μm. The precursor coating 11 thus has a poorer infiltration tendency with respect to the infiltrate M3 (see FIG. 4) than the precursor body 5.

The precursor coating has had no carbon introduced into it to be available therein as a reaction partner for the infiltrate M3 (see FIG. 4) (with the exception of small impurities and the like). As a result the matrix M1 in the precursor body 5 has a proportion of infiltrate M3 reacted with the reaction partner (see FIG. 4) to free infiltrate M3 (see FIG. 4) which is greater than in the matrix M2 of the precursor coating 11.

FIG. 3 shows a perspective view of an apparatus 20 comprising a component 1 and a fluid conveying apparatus 21 from obliquely above, wherein the component 1 is shown partially transparent. In a departure from FIGS. 1 and 2, the cavities 3 are formed as complex channel structures. The channels (cavities 3) are not only in one plane but are formed three-dimensionally in space.

The precursor body 5 is produced analogously to FIGS. 1 and 2 by the quasi-monolithic joining of two semifinished products composed of SiC-carbon material having an internal channel structure. However, the semi-finished products are produced by 3D printing, in this case the binder jet technology. In the binder-jet process a three-dimensional body is built up by applying powder layerwise on a platform and in each layer introducing binder on a point-by-point basis which effects local binding of the powder and, once printing is complete, allows removal of a 3D precursor body from the loose powder bed. The SiC powder used forms a matrix M1 having an average grain size of 50 to 250 μm. The present channel sections of the cavities 3 in the semifinished products must have sufficient accessibility to allow removal of unbound powder from the channels. The precursor body 5 therefore has a multi-part configuration here too. After complete depowdering of the cavities 3 from the 3D printing powder the semifinished products are joined in such a way that the individual channels are connected in a complex duct system. The channels (cavities 3) in the precursor body 5 have a channel diameter of 5 mm and each have two channel openings at the ends of the channels to implement the subsequent precursor coating 11 of the walls 4 of the cavities 3.

The application of the precursor coating 11 and the further processing may be carried out analogously to FIGS. 1 and 2 in conjunction with FIG. 4.

However, if sufficiently emptiable, in particular of the powder during 3D printing, an optional one-piece configuration of the precursor body 5 is likewise contemplated. To this end the precursor body 5 is producible as a monolith by the binder jet process. This allows maximum geometric freedom of the channel geometry (the geometry of the cavities 3). The removal of unbound powder from the intended channel/cavity 3, which is influenced especially by the channel diameter and the flowability of the powder, is the limiting factor here. A monolithically manufactured channel structure (cavities 3) may have a channel diameter of 10 mm for example. These are suitable for example as classical water-conducting cooling channels.

The application of the precursor coating 11 on the wall surfaces 4 of the cavity 3 may be performed according to the coating process described for FIGS. 1 and 2. At a channel diameter of 10 mm this may be done using a coating slip having a solids content of 65 wt %. The subsequent processing of the precursor body 5 with precursor coating 11 may be implemented as per FIGS. 1 and 2 in conjunction with FIG. 4.

Having regard to the schematic detail section of FIG. 4, FIG. 5 shows a real polished section micrograph from an optical microscope which shows the cavity 3 in a component 1 in cross-section. The cavity 3 is formed in a precursor body 5 and a wall surface 4 of the cavity 3 is coated with a precursor coating 11. The precursor body 5 is composed of a first matrix M1 having a microstructure K1 which is coarser than the microstructure K2 of a second matrix M2 which forms the precursor coating 11. A free surface 6 of the precursor body 5 without coating is also apparent. Joint infiltration of the precursor body 5 and the precursor coating 11 with an infiltrate M3 results in a component body 2 composed of precursor body 5 and infiltrate M3 which is coated with a coating 10 of precursor coating 11 and infiltrate M3. In the image direction the layer thicknesses of the coating 10 are 550.940 μm at 2 o'clock, 704.762 μm at 5 o'clock, 652.110 μm at 8 o'clock and 719.315 μm at 11 o'clock.

The detail image from an optical microscope of FIG. 6 shows the boundary zone between the component body 2 and the coating 10. Along the wall surface 4 the coarse material grains K1 of the inorganic matrix M1 of the precursor body 5 and the finer material grains K2 of the inorganic matrix M2 of the precursor coating 11 are adjacent to one other. As a result the infiltrate M3 is also much more finely distributed in the inorganic matrix M2 of the precursor coating 11 than in the inorganic matrix M1 of the precursor body 5. It is apparent that the infiltrate M3 extends in individual regions of the wall surface 4 from interspaces between the material grains K1 of the matrix M1 of the precursor body 5 to the interspaces between the material grains K2 of the matrix M2 of the precursor coating 11. There is thus a sort of skeleton or scaffold composed of infiltrate M3 which extends through precursor body 5 and precursor coating 11.

The even stronger enlargement of FIG. 7 shows a detail image from an electron microscope of FIG. 6. Initially apparent here are the material grains K1 which form the matrix M1 of the porous precursor body 5. Infiltrate M3 has penetrated into the interspaces of the matrix M1 and is now present in two different forms. The infiltrate M3.1 has reacted with a reaction partner and has grown epitaxially on the material grains K1 of the matrix M1 of the precursor body 5. The rest of the interspaces are filled with free infiltrate M3.2.

In the present case the material grains M1 of the matrix M1 of the porous precursor body 5 are silicon carbide, the infiltrate M3 is silicon and as a result in-situ silicon carbide is present as reacted infiltrate M3.1 and silicon is present as free infiltrate M3.2. To this end carbon was present in the precursor body 5 as a reaction partner for the infiltrate M3.

According to FIG. 7 the microstructure of the matrix M2 of the precursor coating 11 is very similar in somewhat finer form. However, due to the lack of incorporation of a reaction partner in the precursor coating 11 the proportion of free infiltrate M3.2 relative to reacted infiltrate M3.1 predominates much more strongly here than in the region of the precursor body 5.

The illustrations of FIGS. 8a and 8b show additional detail images from an optical microscope of a polished section of a component 1 in black-and-white. A component body 2 composed of a porous precursor body 5 composed of a porous matrix M1 and infiltrate M3 is apparent. A coating 10 is arranged on a wall surface 4 of a cavity 3 of the porous precursor body 5. The coating 10 is composed of a porous precursor coating 11 composed of a matrix M2 and also infiltrate M3. It is apparent in each case that the microstructure in the region of the component body 2 is coarser than in the region of the coating 10. Reference is moreover made to the foregoing in respect of FIGS. 5, 6 and 7, the individual features of which may also be realized individually here.

It will be appreciated that a person skilled in the art can also incorporate each individual step of the recited exemplary embodiments individually into the described process or component.

The invention is not restricted to any of the above-described embodiments but may be modified in a very wide variety of ways.

All of the features and advantages apparent from the claims, the description and the drawing, including structural details, spatial arrangements and process steps, may be essential to the invention both individually and in a very wide variety of combinations.

### LIST OF REFERENCE SIGNS

1 Component
2 Component body
3 Cavity
4 Wall surface
5 Porous precursor body
6 Free surface
10 Coating
11 Porous precursor coating
20 Apparatus
21 Fluid conveying apparatus
K1 Material grains (precursor body)
K2 Material grains (coating)
M1 Inorganic matrix (precursor body)
M2 Inorganic matrix (precursor coating)
M3 Infiltrate

1. A component (1) having a component body (2) comprising at least one cavity (3), wherein a wall surface (4) of the component body (2) delimiting the cavity (3) is at least partially coated with a coating (10), wherein the component (1) is formed on the basis of
a one-piece or multi-piece porous precursor body (5) composed of an inorganic matrix (M1), wherein the precursor body (5) comprises the cavity (3),
a porous precursor coating (11) composed of an inorganic matrix (M2), with which a wall surface (4) of the precursor body (5) delimiting the cavity (3) is at least partially coated,
and infiltration of the porous precursor body (5) and the porous precursor coating (11) with an inorganic infiltrate (M3),
wherein the infiltrated precursor body (5) forms the component body (2) and the infiltrated precursor coating (11) forms the coating (10).

2. The component (1) as claimed in claim 1, characterized in that
a) the precursor coating (11) has a poorer wettability with respect to the infiltrate (M3) than the precursor body (5) and/or
b) the matrix (M2) of the precursor coating (11) and the matrix (M1) of the precursor body (5) are each formed from a microstructure (K1, K2), wherein the microstructure (K2) of the matrix (M2) of the precursor coating (11) is finer than the microstructure (K1) of the matrix (M1) of the precursor body (5).

3. The component (1) as claimed in claim 2, characterized in that the microstructure (K2) of the matrix (M2) of the precursor coating (11) has a primary grain size of 0.1 μm to 100 μm, preferably of 0.2 μm to 60 μm, more preferably of 0.5 μm to 30 μm, yet more preferably of 0.8 μm to 8 μm and particularly preferably of 1 μm to 6 μm.

4. The component (1) as claimed in claim 2, characterized in that the microstructure (K1) of the matrix (M1) of the precursor body (5) has a primary grain size of 0.1 μm to 500 μm, preferably of 0.2 μm to 400 μm, more preferably of 0.5 μm to 300 μm, yet more preferably of 1 μm to 250 μm and particularly preferably of 2 μm to 200 μm.

5. The component (1) as claimed in claim 1, characterized in that the precursor coating (11) has a lower infiltration tendency with respect to the infiltrate (M3) than the precursor body (5).

6. The component (1) as claimed in claim 1, characterized in that the infiltrate (M3) exhibits a melting anomaly such that it expands upon solidification.

7. The component (1) as claimed in claim 1, characterized in that the precursor body (5) comprises a higher proportion of a reaction partner for the infiltrate (M3) than the precursor coating (11) and in particular the proportion of infiltrate (M3) that has reacted with the reaction partner to free infiltrate (M3) is greater within the matrix (M1) in the precursor body (5) than within the matrix (M2) of the precursor coating (11).

8. The component (1) as claimed in claim 1, characterized in that the cavity (3) forms a channel or a channel structure.

9. The component (1) as claimed in claim 1, characterized in that the inorganic matrix (M1) of the precursor body (5) is at least substantially or completely formed from the material group of silicon carbide, boron carbide, diamond, molybdenum disilicide, silicon nitride, titanium carbide, zirconium carbide, aluminum nitride, tungsten carbide or combinations of these materials.

10. The component (1) as claimed in claim 1, characterized in that the infiltrate (M3) is silicon or an alloy of silicon in particular with aluminum and/or boron and/or copper.

11. The component (1) as claimed in claim 1, characterized in that the precursor coating (11)
a) is formed by a cast composed of a slip that is formed on the wall surface (4) delimiting the cavity (3); or
b) is deposited on the wall surface (4) delimiting the cavity (3) by a gas phase process.

12. The component (1) as claimed in claim 1, characterized in that the precursor coating (11) is formed of a coating material which corresponds at least substantially to the material of the precursor body (5).

13. An apparatus (20) comprising a component (1) according to claim 1 and comprising a fluid conveying apparatus (21) which is connected to the cavity (3) of the component (1) via a fluid conduit.

14. A process for producing a component (1) having a component body (2) comprising at least one cavity (3) comprising the steps of:
e) providing a single-piece or multi-piece porous precursor body (3) composed of an inorganic matrix (M1) comprising a cavity (3);
f) forming a porous precursor coating (11) composed of an inorganic matrix (M2) on a wall surface (4) of the precursor body (5) delimiting the cavity (3);
g) infiltrating the porous precursor body (5) and the porous precursor coating (11) with an inorganic infiltrate (M3) at a temperature above the liquidus temperature of the infiltrate (M3);
h) cooling the infiltrated precursor body (5) and the infiltrated precursor coating (11) below the solidus temperature of the infiltrate (M3), wherein a coating (10) is formed from the precursor coating (11) and the infiltrate (M3) and a component body (2) is formed from the precursor body (5) and the infiltrate (M3), wherein a material compound is especially formed between the coating (10) and the component body (2).

15. The process as claimed in claim 14, characterized in that
the precursor coating (11) has a poorer wettability with respect to the infiltrate (M3) than the porous precursor body (5) and/or
the matrix (2) of the precursor coating (11) and the matrix (M1) of the precursor body (5) are each formed from a microstructure (K1, K2), wherein the microstructure (K2) of the matrix (2) of the precursor coating (11) is finer than the microstructure (K1) of the matrix (M1) of the porous precursor body (5),
wherein the infiltrate (M3) exhibits a melting anomaly such that it expands as it solidifies,
wherein during cooling surface melt exudations are formed at least substantially exclusively on free surfaces (6) not covered by the precursor coating (11).
